(19) United States
(12) Patent Application Publication
(10) Pub. No.: US 2004/0164701 A1
(43) Pub. Date: Aug. 26, 2004

(54) Electrodynamic machines and components therefor and methods of making and using same

(76) Inventor: William Hallidy, Glendora, CA (US)

Correspondence Address: DUCKOR SPRADLING METZGER, 401 WEST A STREET, SUITE 2400, SAN DIEGO, CA, 92101-7915, US

(21) Appl. No.: 10/410,727

(22) Filed: Apr. 9, 2003

Related U.S. Application Data
(60) Provisional application No. 60/450,009, filed on Feb. 26, 2003.

(51) Int. Cl. H02P 7/36

(52) U.S. Cl. 318/767

(57) ABSTRACT

An alternating current (AC) electrical motor/generator electrodynamic machine and methods include, according to disclosed embodiments of the invention, providing a wound rotor having a polyphase AC winding and a damper winding. The machine can operate as a low slip induction motor or generator, and alternatively can operate as a synchronous motor or generator.

### RELATED APPLICATION

This application claims priority to U.S. provisional patent application, entitled UNIVERSAL ALTERNATING CURRENT MOTOR/GENERATOR AND METHOD OF USING SAME, Serial No. 60/450,009, filed on Feb. 26, 2003, and incorporated herein by reference.

### BACKGROUND OF THE INVENTION

### TECHNICAL FIELD OF THE INVENTION

This invention relates in general to alternating current (AC) electric power motor/generator systems and components therefor as well as methods of making and using such systems and components. More particularly, the invention relates to an electrodynamic machine for functioning as an induction generator adapted to be connected electrically in parallel with an electric power generation grid for the cogeneration of electricity, and functioning as a synchronous generator when not connected in parallel with an electric power generation grid.

### BACKGROUND ART

Historically, prior art induction generators have been the preferred choice for operation in parallel with electric utility grids for the co-generation of electricity in systems wherein the induction generator is not required to also be capable of stand-alone power generation service. Induction generators are not desirable for use as back-up stand-alone emergency generators.

Prior art synchronous generators have historically been the preferred choice for power generation systems connected in parallel with the electric utility grid when the generator must also be capable of stand-alone duty, not connected to the electric utility grid.

Prior art synchronous generators are difficult to connect to and operate in parallel with the electric utility grid without causing harm to the electric grid system and without posing the possibility of fatal or other injuries to utility personnel.

Synchronizing switch gear and safety controls are specified by the electric utilities to permit electric connection and operation of prior art synchronous generators in parallel with the electric utility grid. Such switch gears and safety controls can, in many cases, add an excessive unwarranted and undesirable cost to the complete engine-driven generator system.

### BRIEF DESCRIPTIONS OF THE DRAWINGS

FIG. 1 is a diagrammatic view of the machine of FIG. 1, illustrating it in operation as a synchronous generator;

FIG. 2 is a diagrammatic view of the machine of FIG. 1, illustrating it in an alternate mode of operation as an induction motor or generator;

FIG. 3 is a diagrammatic sectional view of a wound rotor of the machine of FIGS. 1 and 2;

FIG. 4 is a diagrammatic sectional view of a wound rotor of the machine of FIGS. 1 and 2, illustrating a polyphase rotor winding and a squirrel cage damper winding;

FIG. 5 is a diagrammatic sectional view of a wound rotor useful for the machines of FIGS. 1 and 2, illustrating a polyphase rotor winding and a polyphase damper winding; and

FIG. 6 is a diagrammatic view of the machine of FIG. 1, illustrating it selectively operating as a synchronous generator not connected in parallel with an electric utility grid, but able to operate in another mode of operation as an induction generator in parallel with an electric utility grid.

### DETAILED DESCRIPTION OF CERTAIN EMBODIMENTS OF THE INVENTION

A prior art wound rotor induction generator with its slip rings short-circuited operates substantially as a squirrel cage induction generator.

A prior art wound rotor induction generator supplied with DC electrical power to its slip rings operates substantially as a ‘smooth’ or ‘round’ rotor (as opposed to ‘salient pole’) synchronous generator.

Historically, AC electric motors have been substantially categorized as either induction motors or synchronous motors. Induction motors are relatively easy to start but are asynchronous, with the speed of rotation varying with varying load.

Synchronous motors operate at a precise synchronous speed, but are difficult to start. One prior art solution has been to provide an ‘induction-start, synchronous-run’ salient pole synchronous motor in which amortisseur windings operate similar to an induction motor squirrel cage winding to provide enough torque to bring the motor speed close to synchronous speed.

The limitation of the salient pole induction-start, synchronous-run motor has been that the torque provided by the amortisseur windings is pulsating and is minimal. Further, the duty cycle of the amortisseur winding is limited by heating.

A solution according to the disclosed embodiments of the invention is to provide an AC electric motor that can selectively operate as either an induction motor/generator as a synchronous motor/generator with smooth full torque capability and with a substantially continuous duty cycle for either mode of operation.

A prior art wound rotor induction motor with its slip rings short-circuited operates substantially as a squirrel cage induction motor with substantially smooth full torque capability and substantially continuous duty cycle within its power rating. A prior art wound rotor induction motor supplied with DC electrical power to its slip rings operates substantially as a ‘smooth’ or ‘round’ rotor (as opposed to ‘salient pole’) synchronous motor.

Prior art wound rotor induction machines lack the essential amortisseur, or damper winding required to minimize ‘hunting’ when operating as a synchronous motor.

Further, the amortisseur winding is essential in synchronous generators to maintain balanced polyphase voltages in power systems with an unbalanced polyphase load.

In accordance with the embodiments of the invention, it may be desirable to provide a universal AC motor/generator, for some applications, to selectively operate as substantially either an induction motor/generator or as a synchronous motor/generator.

The rotor of the motor/generator of the disclosed embodiments of this invention is provided with a polyphase AC winding connected to slip rings, and with a damper winding such as a squirrel cage winding, or alternatively, a short-circuited polyphase damper winding.

The system of certain embodiments of this invention is further provided with the means to short-circuit the motor/generator rotor polyphase AC windings for operating the motor/generator of this invention as an induction motor/generator machine.

The motor/generator system of an embodiment of this invention is further provided with the means to supply DC power to the motor/generator rotor polyphase windings for operating the motor/generator of this invention as a synchronous motor/generator machine.

During operation of the motor/generator machine of the disclosed embodiment of this invention as an induction motor/generator machine, the rotor damper winding operates as an induction motor/generator rotor squirrel cage winding in parallel with the short-circuited rotor polyphase AC windings. The short-circuited rotor polyphase AC windings provide the major portion of the motor/generator torque, with minimum or low heating and with little or substantially no torque pulsations.

During operation of the motor/generator machine of this invention as a synchronous motor/generator machine, the rotor damper winding operates as an amortisseur or damper winding.

The action of the rotor damper winding in the synchronous motor/generator action is to conduct induced electric current in the direction to oppose the change in magnetic flux that induced the current.

In effect, it dampens the effect of momentary changes in instantaneous speed in a motor, and dampens the effect of changes in magnet field flux caused by rapidly changing or unbalanced loads in a generator.

According to a preferred embodiment of the invention, a rotating electrical machine has a polyphase armature winding in its stator and has a polyphase winding and a damper winding in its rotor.

The polyphase armature winding is preferably, but not necessarily, 3-phase to conform to the bulk of the world's electrical systems.

According to the disclosed embodiment of the invention, the rotor polyphase winding preferably, but not necessarily, has the same number of phases as the stator armature winding. The damper winding is preferably a squirrel cage winding, but can be any winding that can operate as a short-circuited rotor winding for operation of the machine as an induction motor/generator and that can operate as an amortisseur, or damper, winding for operation of the machine of this invention as a synchronous motor/generator machine.

The machine and method of an embodiment of this invention are provided with means to short-circuit the rotor polyphase windings for operation of the machine as an induction AC motor/generator machine.

Further, the machine and method of an embodiment of this invention are provided with means to energize the rotor polyphase winding with variable magnitude DC current for operation of the machine as a synchronous AC motor/generator machine.

According to an embodiment of the invention, the rotor damper winding operates as an induction machine short-circuited rotor winding in parallel with the short-circuited rotor polyphase winding when the machine is performing as an induction motor/generator machine.

According to an embodiment of the invention, the rotor damper winding operates as an amortisseur, or damper, winding when the machine is operating as a synchronous generator.

In accordance with a preferred embodiment of the invention, an electrodynamic machine in the form of a universal AC motor/generator system wherein the machine performs as an induction generator for operation in parallel with an electric utility grid or other source of electrical power, and performs as a synchronous generator when not connected to an electric utility grid or other source of electrical power.

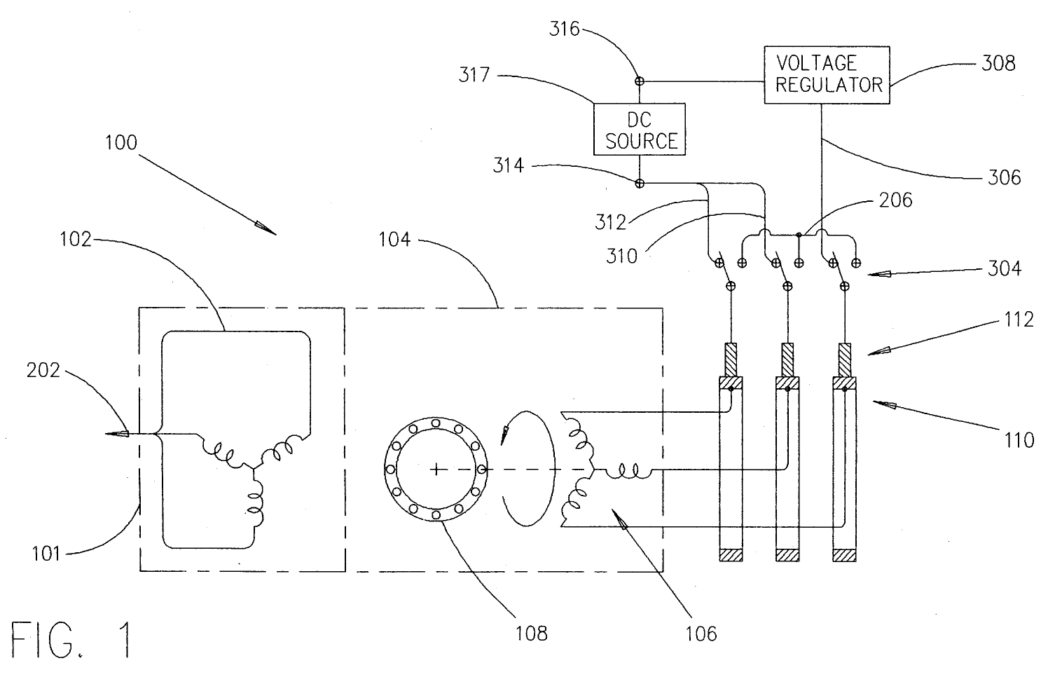

Referring now to the drawings, in FIG. 1 an electrodynamic machine is shown a universal alternating current motor/generator 100 constructed in accordance with an embodiment of this invention.

The machine 100 includes a stator armature 101 having a stator polyphase armature winding 102 and a wound rotor assembly 104.

The wound rotor assembly 104 includes a rotor polyphase winding 106 and a damper winding 108.

The rotor polyphase winding 106 is connected to slip rings 110, on which ride slip ring brushes 112. The rotor polyphase winding 106 preferably, but not necessarily, has the same number of phases as the stator polyphase armature winding 102.

The damper winding 108 is preferably, but not necessarily, constructed as a squirrel cage winding.

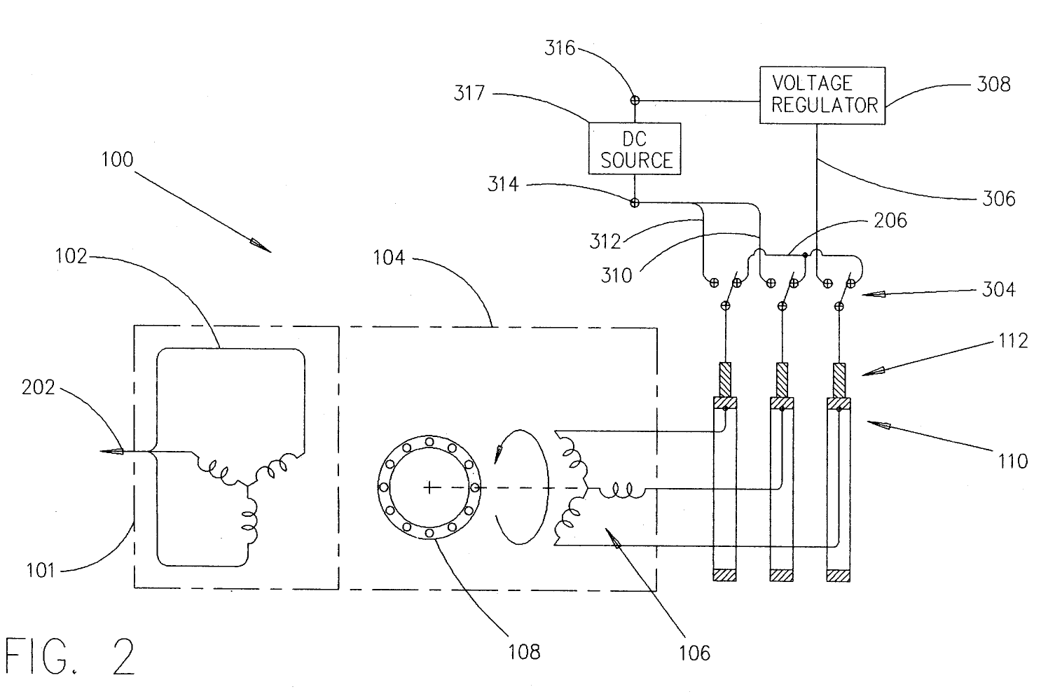

As shown in FIG. 2, the universal alternating current motor/generator machine 100 of the embodiment of this invention is shown operating in an alternate mode of operation as an induction motor/generator mode of operation.

Power leads 202 connect the stator polyphase winding 102 to a contactor, not shown, for connecting the machine 100 to an electric utility grid.

Contactor 304 connects the slip ring brushes 112 to a short-circuiting conductor 206.

In operation, the damper winding 108 operates as a short-circuited induction motor rotor winding in parallel with the short-circuited rotor polyphase winding 106. In this manner, the machine 100 can operate either as an induction motor or an induction generator.

Referring again to FIG. 1, the universal alternating current motor/generator electrodynamic machine 100 of this embodiment of the invention is shown in operation in a synchronous generator mode of operation.

Power leads 202 connect the stator polyphase winding 102 to a contactor, not shown, for connecting the machine 100 to a load not connected to an electric utility grid.

Contactor 304 connects one of the slip ring brushes 112 to a conductor 306 connected to a voltage regulator 308 which is connected to one polarity 316 of a source 317 of DC electric power.

Contactor 304 further connects two of the slip ring brushes 112 to conductors 310 and 312 connected to the second polarity of the DC electric power source 317.

In operation, as shown in FIG. 1, the universal alternating current motor/generator electrodynamic machine 100 of the embodiment of this invention operates as a smooth, or round, (as opposed to a salient pole) rotor synchronous generator. The damper winding 108 operates as an amortisseur, or damper, winding.

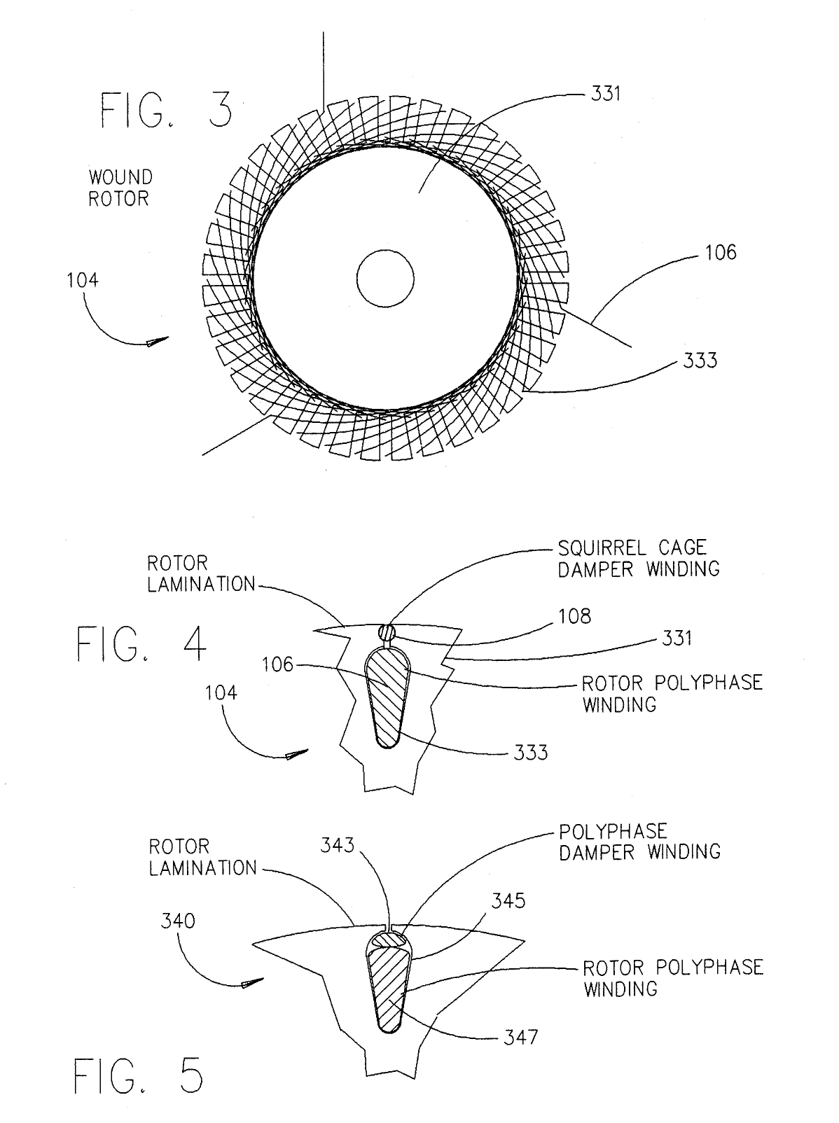

Referring now to FIGS. 3 and 4, the wound rotor 104 has a laminated core 331 having radial slots such as slot 333 disposed about substantially the entire periphery of the rotor 104 for receiving the polyphase winding 106. As shown in FIG. 4, the polyphase winding 106 is imbedded in the slot 333, and the squirrel cage winding 108 is embedded on top of the polyphase winding 106 near the surface of the laminated core 331.

Referring now to FIG. 5, there is shown a rotor 340, which is similar to the rotor 104, except that a wound polyphase damper winding 343 is used in place of the squirrel cage winding 108. The damper winding 343 is positioned within a radial slot 345, which also has a polyphase winding 347, which is similar to the winding 106 of FIG. 4.

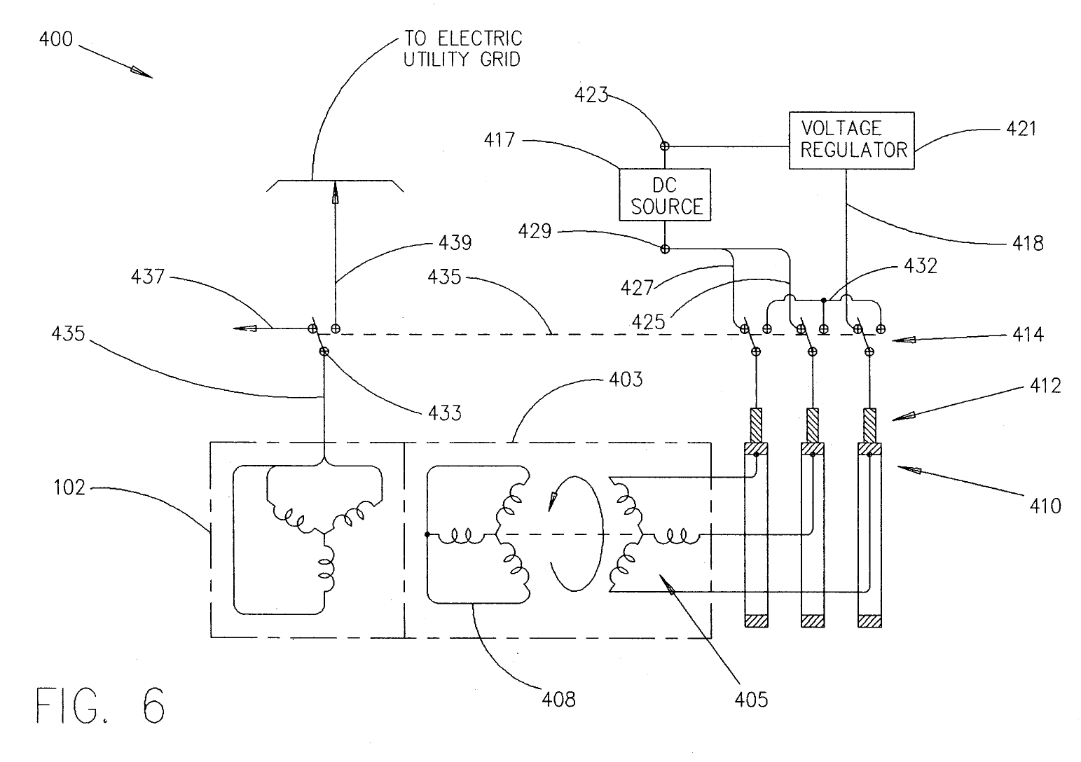

FIG. 6 shows a universal alternating current motor/generator electrodynamic machine 400 constructed according to an embodiment of this invention and is similar to the machine 100, except that the rotor for the machine 400 has a polyphase damper winding intead of a squirrel cage damper winding, and the illustration of how the machine may be connected in parallel with an electric power generation grid. In FIG. 6, the machine 400 is shown operating as a standalone synchronous generator and not connected to the grids.

The machine 400 includes a stator armature 102 which is similar to the armature 101 of FIGS. 1 and 2, and a wound rotor assembly 403 having a polyphase winding 405 and a polyphase damper winding 408 similar to the winding 343 of FIG. 5.

A set of slip rings 410 and brushes 412 connect the polyphase winding to a contactor 414 in a similar manner and for a similar function as the slip rings 110, brushes 112 and contactor 30 of FIG. 1 and FIG. 2. In this regard, the contactor 414 can connect electrically the brushes 412 to a DC source 417 to enable the machine 400 to function as a synchronous motor or generator as indicated in FIG. 6. In this regard, in a manner similar to that shown in FIGS. 1 and 2, a conductor 418 interconnects the contactor 414 and a voltage regulator 421, which is connected to a terminal 423 for the DC source 417. Conductors 425 and 427 connect the contactor 414 and the other terminal 429 of the DC source 417.

A short circuit conductor 432 short circuits the brushes 412 when the contactor 414 is disposed in its alternate position to cause, in turn, the machine 400 to function in an alternate mode of operation as an induction motor or generator when the rotor assembly 403 rotates relative to the stator armature 102.

A transfer switch 433 has a switch interlock 435 connected to and operating in unison with the contactor 414 so that when the contactor 414 is disposed in its “synchronous” position as shown in FIG. 6, the switch 433 interconnects an output 435 of the stator armature to an output conductor 437. Thus, the interlock 435 prevents the output 435 from being connected electrically inadvertently to a conductor 439 connected to an electric utility grid. In this regard, the interlock 435 prevents the machine 400 from inadvertently being connected in parallel with the grid when the machine 400 is functioning as a synchronous generator so that the machine 400 is thereby prevented from inadvertently causing damage to the grid or injury to personnel working with the grid.

The descriptions of the embodiments of this invention are to be construed as illustrative examples only and are for the purpose of teaching those skilled in the art the best mode for carrying out the invention. The details may be varied substantially without departing from the true spirit and scope of the invention as recited in the appended claims.

What is claimed is:

1. An electrodynamic machine, comprising:
a stator armature having armature winding means;
a wound rotor having a polyphase winding; and
a damper winding on said wound rotor for permitting electric currents to be induced by changes in the magnetic flux linking the rotor magnetic field and the stator armature magnetic field, said electric currents flowing in such a direction as to oppose changes in magnetic flux linkages.

2. An electrodynamic machine according to claim 1, wherein said damper winding is a wound polyphase damper winding.

3. An electrodynamic machine according to claim 1, wherein said damper winding is a squirrel cage winding.

4. An electrodynamic machine according to claim 1, further including a contactor for disconnecting a source of direct current from said polyphase winding and short circuiting said polyphase winding to enable the machine to function as an induction motor or generator.

5. An electrodynamic machine according to claim 1, further including a contactor for connecting a source of direct current to said polyphase winding and disconnecting a short circuit therefrom, to enable the machine to function as a synchronous motor or generator.

6. An electrodynamic machine according to claim 1, further including a contactor for connecting said armature winding means to the electric power generation grid for the cogeneration of electricity.

7. A wound rotor for an electrodynamic machine having a stator armature and armature winding means to form an electrodynamic machine, comprising:
a lamination core having radial slots disposed about substantially the entire periphery thereof;
a polyphase winding wound in said slots; and
a damper winding on the wound rotor for permitting electrical currents to be induced by changes in the magnetic flux linking the rotor magnetic field and the stator armature magnetic field, said electric currents flowing in such a direction as to oppose changes in magnetic flux linkages.

8. A wound rotor according to claim 7, wherein said damper winding is a wound polyphase damper winding.

9. A wound rotor according to claim 7, wherein said damper winding is a squirrel cage winding.

10. A method of making a synchronous generator, comprising:
providing a wound rotor with a polyphase winding for interacting electrodynamically with a stator armature having armature winding means to form an electrodynamic machine;
providing a damper winding on said wound rotor;
connecting said polyphase winding with a source of direct current to cause the machine to function as a synchronous motor or generator when the rotor rotates relative to the stator armature;
providing a damper winding on the wound rotor to enable inducing electric currents by changes in the magnetic flux linking the rotor magnetic field and the stator armature magnetic field, said electric currents flowing in such a direction as to oppose changes in magnetic flux linkages.

11. A method according to claim 10, further including disconnecting said source of direct current from said polyphase winding and short circuiting said polyphase winding to cause the machine to function as an induction motor or generator when the rotor rotates relative to the stator armature.

12. A method of generating alternating current, comprising:
providing a wound rotor with a polyphase winding for interacting electrodynamically with a stator armature having armature winding means to form an electrodynamic machine;
providing a damper winding on said wound rotor;
connecting said polyphase winding with a source of direct current to cause the machine to function as a synchronous motor or generator when the rotor rotates relative to the stator armature; and
inducing electric currents by the damper winding by changes in the magnetic flux linking the rotor magnetic field and the stator armature magnetic field, said electric currents flowing in such a direction as to oppose changes in magnetic flux linkages.

13. A method according to claim 12, further including disconnecting said source of direct current from said polyphase winding and short circuiting said polyphase winding to cause induction motor or generator action when the rotor rotates relative to the stator armature.

14. A method of making a wound rotor, comprising:
providing a core having radial slots disposed about the periphery thereof;
winding a polyphase winding in the slots of the core; and
disposing a damper winding in said slots.

15. A method according to claim 14, wherein said damper winding is a wound polyphase damper winding.

16. A method according to claim 14, wherein said damper winding is a squirrel cage winding.
